(19) United States
(12) Patent Application Publication
(10) Pub. No.: US 2003/0141368 A1
(43) Pub. Date: Jul. 31, 2003

(54) System and method for obtaining information from a bar code for use with a healthcare system

(76) Inventors: Florante Pascual, Mississauga (CA); Meetali Acharya, Burlington (CA); Eric S. Paul, North York (CA); Gordon J. Wilkes, Newmarket (CA)

Correspondence Address: FRANCIS J. KOWALIK, ESQ., Corporate Counsel, Law Department, BAXTER INTERNATIONAL INC., One Baxter Parkway, DF3-2E, Deerfield, IL, 60015, US

(21) Appl. No.: 10/160,565

(22) Filed: May 31, 2002

Related U.S. Application Data
(63) Continuation-in-part of application No. 10/135,180, filed on Apr. 30, 2002.
Application No. 10/135,180 is a continuation-in-part of application No. 10/059,929, filed on Jan. 29, 2002.
(60) Provisional application No. 60/377,027, filed on Apr. 30, 2002.
(60) Provisional application No. 60/376,625, filed on Apr. 30, 2002.
(60) Provisional application No. 60/376,655, filed on Apr. 30, 2002.

(51) Int. Cl. G06F 17/60; G06K 7/10; G08C 21/00

(52) U.S. Cl. 235/462.07; 705/2

(57) ABSTRACT

A method or system for obtaining information from a bar code comprising the steps of maintaining a database of a plurality of algorithms for decoding a bar code, scanning a bar code associated with a particular item, determining the length of the bar code, identifying algorithms from said database for decoding a bar code of the determined length, applying the identified algorithms to the scanned bar code, and verifying one of the identified algorithms as a correct algorithm for obtaining and utilizing information or data from the scanned bar code. The verifying step can be determining if a segment of the scanned bar code contains a portion of the information of the scanned bar code within an expected range for the chosen segment.

### RELATED APPLICATIONS

The present application claims priority from U.S. Patent Serial No. 60/377,027 filed Apr. 30, 2002; U.S. Patent Serial No. 60/376,625, filed Apr. 30, 2002; U.S. Patent Serial No. 60/376,655, filed Apr. 30, 2002; and U.S. patent Ser. No. 10/135,180 filed Apr. 30, 2002, which is a continuation-in-part of copending U.S. patent Ser. No. 10/059,929 filed Jan. 29, 2002, and incorporates such applications herein by reference.

Additionally, the present application is being filed concurrently with and incorporates by reference the following applications: “Automated Messaging Center System and Method For Use With A Healthcare System” (Attorney Docket No. EIS-5849 (1417G P 749)), Ser. No. ______; “Infusion Therapy Bar Coding System and Method” (Attorney Docket No. EIS-5850 (01417GP0750)), Ser. No. ______; “System and Method for Providing Multiple Units of Measurement” (Attorney Docket No. EIS-5851(1417GP0751)), Ser. No. ______; “Nursing Order Workflow System and Method” (Attorney Docket No. EIS-5899(1417GP0756)), Ser. No. ______; “Healthcare Database Management Offline Backup and Synchronization System and Method” (Attorney Docket No. EIS-5895(1417G-P752)), Ser. No. ______; “Biometric Security For Access To A Storage Device For A Healthcare Facility” (Attorney Docket No. EIS-5847(1417G-P720)), Ser. No. ______; “Storage Device For Health Care Facility” (Attorney Docket No. EIS-5848(1417G P 747)), Ser. No. ______; “System And Method For Supporting Clinical Decisions During Patient Care And Treatment” (Attorney Docket No. EIS-5896(1417G-P753)), Ser. No. ______; “System And Method For Facilitating Patient Care And Treatment” (Attorney Docket No. EIS-5898(1417G-P755)), Ser. No. ______; “System And Method For Facilitating Orders During Patient Care And Treatment” (Attorney Docket No. EIS-5900(1417G-P757)), Ser. No. ______; and, “Pharmacy System And Method” (Attorney Docket No. EIS-5901(1417G-P758)), Ser. No. ______.

### DESCRIPTION

1. Technical Field

The present invention is generally directed to a method or system for obtaining information or data from a bar code associated with an item in a healthcare facility, and more particularly to a method or system for identifying, applying and verifying an algorithm for obtaining information from a bar code associated with an item in a healthcare facility when the manufacturer, repackager or other source information about the bar coded item is not readily known.

2. Background of the Invention

Certain healthcare facility systems utilize bar code technology to implement some or all of the necessary processes involved in running the facility. The bar code technology is particularly conducive for use with the large quantity of medications or drugs typically utilized by the healthcare facility. Such medications come from a variety of sources, and may include an equal variety of bar code schemes (e.g., a different one for each drug manufacturer or supplier). However, in view of the extreme importance of administering the correct medications to patients, and tracking or keeping inventory of such medications, it is critical that correct information is read from the bar code.

In addition to an identification code, a bar code may have additional information embedded in the code. The content and positioning of such information may vary depending on the labeler. For example, one supplier may include a fixed-length lot number before the identification code and a fixed length expiration date after the identification code while another supplier may have the same information in different positions or use a delimiter characters rather than a fixed length. A third supplier might exclude the lot number but include the expiration date or include different information altogether. Moreover, the same item can have different identification codes embedded in the bar code. For example, if a drug comes from a manufacturer, it may have a different identification code within the bar code from exactly the same drug if it has been re-packaged and re-labeled. Typically, all of the information in the bar code is numeric, so special logic (i.e., an algorithm) is necessary to isolate the identification code and other information or data without error.

The software previously used in connection with bar coded items and bar code readers had a number of limitations. For example, the same item could not be identified with multiple identification codes; the format of the bar code could not vary for the same item; and, the rules for parsing the bar code could not automatically be determined from the bar code itself using other data in the database (that is, additional information about the item would need to be specified at the time of scanning). Moreover, for most of such software, there was no automatic substitution of equivalent items. If automatic substitution was allowed, there was no means of specifying that no substitution should take place for a particular instance of using an item.

### SUMMARY OF THE INVENTION

The present invention provides a method and system for decoding a bar code associated with a specific item. The method is implemented on a computer system or other microprocessor controlled device, and is preferably used in connection with a healthcare facility system. In this regard, the method can be maintained as a software program on a computer readable medium (such as a CD, floppy or hard drive) having code segments for performing the steps of the method. The method is capable of decoding bar codes from known sources as well as bar codes from unknown sources.

Special logic or algorithms are necessary to obtain the information or data embedded in a bar code. The algorithms contain rules that define the syntax of the bar code and parse the code into fields or segments defined by the rules. When the manufacturer, repackager or other source identifying information is known, the appropriate algorithm is applied by a healthcare facility system, and the appropriate segments are generated. The information in such segments is then utilized by the facility's system. However, when the manufacturer or repackager is not known, the present invention applies a number of possible algorithms and then analyses the segments to determine which algorithm should be utilized by the system.

In one embodiment, a method of obtaining information from a bar code when the manufacturer or repackager or other source identifying information of an item associated with the bar code is not known is disclosed. The method comprises the step of maintaining a database of a plurality of algorithms for decoding bar codes. Preferably all known algorithms associated with items normally used with the healthcare facility system are included in the database. The method further comprises determining a length of a bar code associated with an item and identifying all algorithms from the database for decoding a bar code having the determined length. Next, the method comprises applying each identified algorithm to the bar code to break it into segments; and, verifying every segment of the bar code determined from each identified algorithm. For example, the algorithm could produce a segment that is a date. If the value does not represent a date, then the algorithm can be rejected. In another example, an algorithm may produce a segment that is an identification code for a drug. If there is no drug containing that identification code, the algorithm can be rejected. Every segment has verification rules attached. If there is only one fully verified algorithm, the segments for it are used. If the bar code has a length with no matching algorithms or there is no verified algorithm, the method may comprise generating an error message. If there is more than one verified algorithm, the method can comprise generating a drop down menu for selection of one of the verified algorithms by a user of the system.

The identifying step can comprise identifying a first algorithm, and the applying step can comprise parsing the bar code into a plurality of segments as required by the first algorithm, each segment containing a portion of said information contained in the bar code. The verifying step can then comprise determining if one of the plurality of segments parsed by the first algorithm contains a portion of information within a predetermined range of information associated with the segment. For example, the one segment can be associated with the portion of information concerning a date of the item. The verifying step would then determine if the one segment is a valid date.

The identifying step can comprise identifying a first algorithm and a second algorithm associated with the length of the scanned bar code. In this regard the verifying step can includes parsing the bar code into a first plurality of segments as required by the first identified algorithm and determining for one of the first plurality of segments whether the one segment is within a predetermined range of values, and similarly parsing the bar code into a second plurality of segments as required by the second identified algorithm and determining for one of the second plurality of segments whether the one segment from the second plurality of segments is within a predetermined range value. The method then selects one of the first and second algorithms having a verified segment. If both algorithms are verified, the method can comprise generating a drop down menu for selection of one of the first and second algorithms by a user of the system. These steps can be reiterated for additional identified algorithms as well.

In an alternative verifying step, the step can comprise determining if valid interdependencies exist between a first segment of the plurality of segments and a second segment of the plurality of segments.

In another embodiment, a method of obtaining information from a bar code comprises the steps of maintaining a database of algorithms for decoding bar codes, scanning the bar code with a bar code reader; determining a length of the scanned bar code, and generating an error code if the length is less than a predetermined length. If the length is not less than the predetermined value, the method comprises identifying all algorithms from the database for decoding a bar code having the determined length, applying each identified algorithm to the bar code, verifying a portion of information from the bar code determined from each identified algorithm; and, selecting a verified algorithm to obtain the information.

In yet another embodiment a method of obtaining information from an item having a bar code comprises the steps of maintaining a first database of algorithms for decoding bar codes for use when a manufacturer or other source identifying information of an item is known, maintaining a second database of algorithms for decoding bar codes for use when a manufacturer of an item is not known, scanning a bar code from an item, utilizing an algorithm from the first database when the manufacturer of the item is known to obtain information from the scanned bar code; and, utilizing an algorithm from the second database when the manufacturer of the item is not known to obtain information from the bar code. When utilizing an algorithm from the second database, the method comprises the steps of determining a length of the scanned bar code, identifying all algorithms from the second database for decoding a bar code having the determined length, applying each identified algorithm to the bar code, verifying a portion of information from the bar code determined from each identified algorithm; and, selecting a verified algorithm to obtain the information.

Further aspects of the invention are disclosed in the detailed description of the preferred embodiment, the drawings and the claims.

### BRIEF DESCRIPTION OF THE DRAWINGS

FIG. 1 is a perspective view of a bar code scanning system in accordance with the present invention; and,

FIG. 2 is flow chart of the software implemented by the system of FIG. 1.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a method and system for obtaining information from a bar coded item 10. While this invention has uses in practically any environment utilizing bar codes, it is preferably used in connection with a healthcare facility system. Among other things, such systems may use bar codes to track and identify medications, and to keep an inventory of such medications. One healthcare facility system that utilizes such technology is marketed as the Autros System.

Bar codes typically include a variety of information regarding an item the bar code is applied to. In this regard, the bar code can typically be broken down into a plurality of segments, each segment having a particular type of information. An algorithm in a computer system can be designed to obtain and utilize such information. Typically, the algorithm initially parses the bar code into the plurality of segments and decodes each segment.

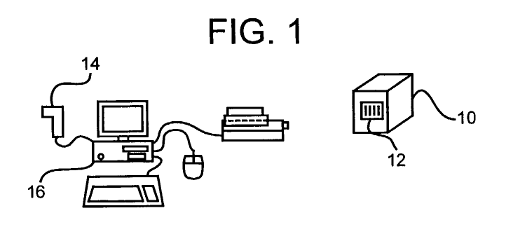

In an example of the preferred embodiment of the invention, an item 10, such as package of medication as shown in FIG. 1, is provided with a bar code 12 having a variety of information regarding the item. The bar code can be broken down into a plurality of segments wherein each segment includes a portion of the total information contained within the code. For example, the bar code may include segments that indicate the source of the item (i.e., manufacturer, distributor, repackager etc.), the date of packaging, the expiration date, and the type and amount of medication.

The bar code is read or scanned by a bar code reader 14 which then transmits the scanned code into a computer system 16, or other microprocessor device capable of implementing a software program. While the bar code reader 14 of FIG. 1 is shown hard wired to the computer system 16, it may also have a wireless connection to the system. Alternatively, the bar code reader may be part of a device having the necessary software for implementing the present method.

The system includes a first database of algorithms (or tables linked to or identifying the location of such algorithms) for parsing bar codes when the source, or other identifying information relating to the bar code is known. Preferably, the first database includes tables and/or algorithms that encompass all bar code schemes that are currently in use that the healthcare facility system is likely to encounter. Such algorithms are preferably generalized to anticipate future variations of such bar code schemes. In particular, the schemes can permit specification for each manufacturer or repackager of specific named segments within a bar code, the sequence (i.e., relative position) of such segments, the format for the segments, and the length of each segment (or maximum length if the segment is a delimited segment of varying length). The formats for the segments can be, for example: alpha; alpha-numeric; MM/DD/YYYY (for month/day/year); YYYYMMDD (for year/month/day); numeric; or delimited with specified characters. Other formats can be defined as required.

In practice, if the identifying information is known, the system locates the appropriate algorithm in or from the first database, and utilizes the selected algorithm for decoding the bar code. The information provided in the bar code is then used in the system as appropriate (e.g., for maintaining inventory).

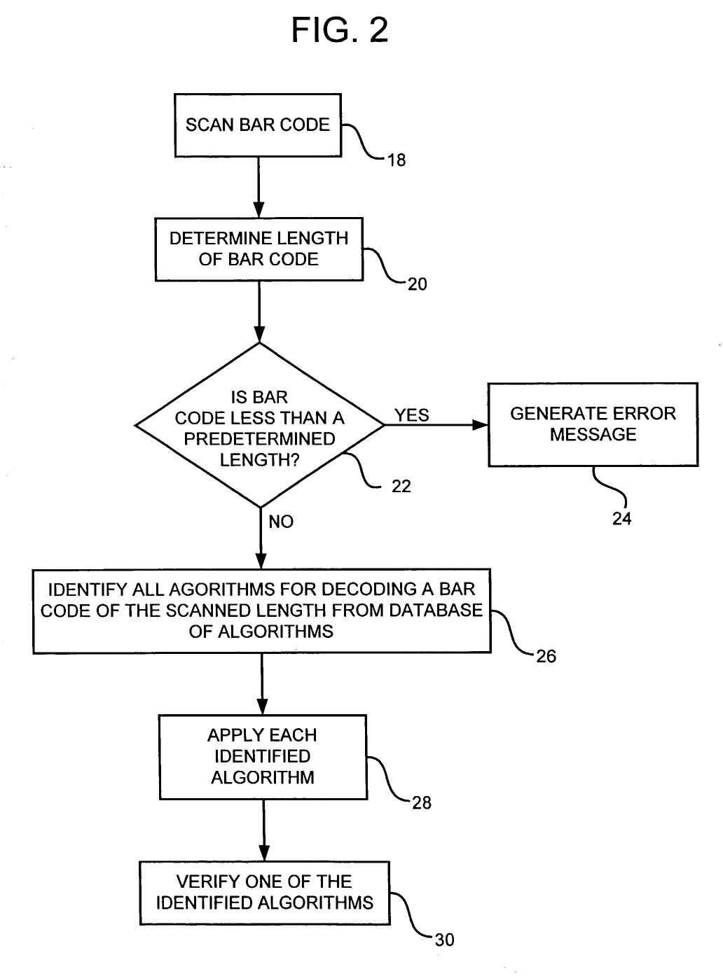

A separate approach is utilized when such identifying information is not known. In this instance, the software program includes a second database of algorithms for decoding bar codes (Although described in terms of a first database and a second database for purposes of conceptually describing the invention, one database or set of algorithms can be utilized by both parts of the program, i.e., the first part for known sources of bar codes, and the second part for unknown sources. The invention is not intended to be limited to having two separate databases.). As shown in FIG. 2, the system or program initially scans 18 the bar code, and determines 20 the length of the scanned bar code (this may also occur when the bar code is from a known source). If the length of the bar code is less than a predetermined minimum length (i.e., less than any of the lengths required by all of the algorithms in the second database), the system can simply generate or return an error code or message 22. Otherwise, the system identifies 24 all of the algorithms that match the scanned length. Typically, to match an algorithm, the scanned length of the bar code lies between the total minimum segment lengths and the total maximum segment lengths for a particular algorithm.

The computer system applies 26 the identified algorithms, and verifies 28 which algorithm is the correct one for properly obtaining information from the bar code for use in the healthcare facility system or program. One way to verify an algorithm is to examine one or more of the segments created to determine if such segments contain the portion of information expected in such segments. For example, if one segment as parsed by a first algorithm is supposed to be a date, the program ensures that the segment is within a valid range of dates. That is, the program analyses the portion of information to determine if it is in the proper format, and whether it is in the proper range for such format. The program may then either reject the algorithm, if the portion of information does not meet the desired expectations, or it may move to a second (and then possibly a third etc.) segment to further determine if such segments have a portion of information expected (for that segment type as designated by the algorithm). Alternatively, the program can stop after checking only a first segment. This process is repeated with the any other algorithms that match the length of the scanned bar code.

If more than one algorithm is verified as being a possible correct algorithm for decoding the scanned bar code, the program can provide a message and/or a drop down menu to enable a user of the system to pick which of the verified algorithms is the appropriate algorithm to utilize.

The parsing and matching process described is typically implemented using logic that treats each segment of the bar code independently. One alternative embodiment would permit a user to specify interdependencies between values in different segments within a bar code in order to obtain proper verification. This would be useful for situations where a bar code containing a large amount of data or information, included a cyclic redundancy check or other inter-segment dependencies. For example, if the second segment is expected to be a manufactured date, and a fourth segment is an expiration date, the program would check to ensure that the expiration date came after the manufactured date. Numerous other interdependencies could be utilized to verify the algorithm.

The software utilized in the computer system may need to treat different items (which necessarily have different identification codes) identically. For example, a drug product that has the identical therapeutic ingredients to another drug from a different manufacturer and has the same strength and form might need to be used interchangeably with the first drug unless a doctor has specified that no substitutes be allowed. The present system can support such equivalence by maintaining healthcare facility defined tables of equivalences. Items can only be defined as equivalent if they have the same strength, dosage form, administration route, and therapeutic subclass.

While specific embodiments have been illustrated and described, numerous modifications are possible without departing from the spirit of the invention, and the scope of protection is only limited by the scope of the accompanying claims.

What is claimed is:

1. A method of obtaining information from a bar code when the manufacturer or repackager of an item associated with the bar code is not known, the method comprising the steps of:
maintaining a database of a plurality of algorithms for decoding bar codes;
determining a length of a bar code associated with an item;
identifying all algorithms from said database for decoding a bar code having said length;
applying each identified algorithm to said bar code; and,
verifying a portion of information from said bar code determined from each said identified algorithm.

2. The method of claim 1 further comprising generating an error message if said length of said bar code is less than a predetermined length.

3. The method of claim 1 wherein said identifying step comprises identifying a first algorithm, and said applying step comprises parsing said bar code into a plurality of segments as required by said first algorithm, each segment containing a portion of said information contained in said bar code.

4. The method of claim 3 wherein said verifying step comprises determining if one of said plurality of segments contains a portion of information within a predetermined range of information associated with said segment.

5. The method of claim 4 wherein said one segment is associated with information concerning a date of said item.

6. The method of claim 5 wherein said verifying step comprises determining if said one segment is a valid date.

7. The method of claim 1 wherein said identifying step comprises identifying a first algorithm and a second algorithm.

8. The method of claim 7 wherein said verifying step includes:
parsing said bar code into a first plurality of segments as required by said first algorithm and determining for one of said first plurality of segments whether said one segment is within a predetermined range of values;
parsing said bar code into a second plurality of segments as required by said second algorithm and determining for one of said second plurality of segments whether said one segment from said second plurality of segments is within a predetermined range value; and,
selecting one of said first and second algorithms having a verified segment.

9. The method of claim 7 further comprising generating a drop down menu for selection of one of said first and second algorithms by a user when said verifying steps verifies both said first algorithm and said second algorithm as valid algorithms for said bar code.

10. The method of claim 3 wherein said verifying step includes determining if valid interdependencies exist between a first segment of said plurality of segments and a second segment of said plurality of segments.

11. The method of claim 1 further comprising using information supplied from a verified algorithm.

12. The method of claim 8 further comprising using information supplied from said selected algorithm.

13. A method of obtaining information from a bar code comprising the steps of:
maintaining a database of algorithms for decoding bar codes;
scanning said bar code with a bar code reader;
determining a length of said bar code;
generating an error code when said length is less than a predetermined length;
identifying all algorithms from said database for decoding a bar code having said length when said length is greater than said predetermined length;
applying each identified algorithm to said bar code;
verifying a portion of information from said bar code determined from each said identified algorithm; and,
selecting a verified algorithm to obtain said information.

14. The method of claim 13 wherein said identifying step identifies a first algorithm from said plurality of algorithms and a second algorithm from said plurality of algorithms.

15. The method of claim 14 wherein said verifying step comprises:
parsing said bar code into a first plurality of segments as required by said first identified algorithm and determining for one of said first plurality of segments whether said one segment is within a predetermined range of values; and,
parsing said bar code into a second plurality of segments as required by said second identified algorithm and determining for one of said second plurality of segments whether said one segment from said second plurality of segments is within a predetermined range value.

16. The method of claim 15 wherein said selecting step comprises picking one of said first and second algorithms having a verified segment.

17. The method of claim 13 wherein said verifying step comprises parsing said bar code into a plurality of segments as required by one of said identified algorithms, and determining if valid interdependencies exist between a first segment of said plurality of segments and a second segment of said plurality of segments.

18. The method of claim 15 further comprising providing a drop down menu for selection of one of said first and second algorithms by a user when said verifying steps verifies both said first algorithm and said second algorithm as valid algorithms for said bar code.

19. The method of claim 13 further comprising obtaining information from said bar code utilizing said selected algorithm.

20. A method of obtaining information from an item having a bar code comprising the steps of:
maintaining a first database of algorithms for decoding bar codes for use when a manufacturer of an item is known;
maintaining a second database of algorithms for decoding bar codes for use when a manufacturer of an item is not known;
scanning a bar code from an item;
utilizing an algorithm from said first database when said manufacturer of said item is known to obtain information from said scanned bar code; and,
utilizing an algorithm from said second database when said manufacturer of said item is not known to obtain information from said bar code.

21. The method of claim 20 wherein said utilizing an algorithm from said second database comprises the steps of:
determining a length of said scanned bar code;
identifying all algorithms from said second database for decoding a bar code having said length;
applying each identified algorithm to said bar code;
verifying a portion of information from said bar code determined from each said identified algorithm; and,
selecting a verified algorithm to obtain said information.

22. The method of claim 21 wherein said identifying step identifies a first algorithm from said second database and a second algorithm from said second database.

23. The method of claim 22 wherein said verifying step comprises:
parsing said bar code into a first plurality of segments as required by said first identified algorithm and determining for one of said first plurality of segments whether said one segment is within a predetermined range of values; and,
parsing said bar code into a second plurality of segments as required by said second identified algorithm and determining for one of said second plurality of segments whether said one segment from said second plurality of segments is within a predetermined range value.

24. The method of claim 23 wherein said selecting step comprises picking one of said first and second algorithms having a verified segment.

25. The method of claim 21 wherein said verifying step comprises parsing said bar code into a plurality of segments as required by one of said identified algorithms, and determining if valid interdependencies exist between a first segment of said plurality of segments and a second segment of said plurality of segments.

26. The method of claim 23 further comprising providing a drop down menu for selection of one of said first and second algorithms by a user when said verifying steps verifies both said first algorithm and said second algorithm as valid algorithms for said bar code.

27. The method of claim 21 further comprising obtaining information from said bar code utilizing said selected algorithm.

28. A system for obtaining information from a bar code comprising:
a bar code scanner for scanning a bar code associated with an item;
a program maintained on a computer readable medium for decoding a bar code scanned by said bar code scanner, said program including
a first code segment for maintaining a database of a plurality of algorithms for decoding bar codes;
a second code segment for determining a length of a bar code associated with an item;
a third code segment for identifying all algorithms from said database for decoding a bar code having said length;
a fourth code segment for applying each identified algorithm to said bar code; and,
a fifth code segment for verifying a portion of information from said bar code determined from each said identified algorithm.

29. The system of claim 28 wherein said program further comprises a sixth code segment for generating an error message if said scanned bar code length is less than a predetermined value.

30. A program maintained on a computer readable medium for obtaining information from a bar code comprising:
a first code segment in said program for maintaining a database of a plurality of algorithms for decoding bar codes;
a second code segment in said program for determining a length of a bar code associated with an item;
a third code segment in said program for identifying all algorithms from said database for decoding a bar code having said length;
a fourth code segment in said program for applying each identified algorithm to said barcode; and,
a fifth code segment in said program for verifying a portion of information from said bar code determined from each said identified algorithm.

31. The method of claim 4 wherein said one segment is associated with information relating to an identification code for a drug.

32. The method of claim 31 wherein said verifying step comprises determining if said segment is a valid drug identification code.
